(19) United States
(12) Patent Application Publication
(10) Pub. No.: US 2026/0195932 A1
(43) Pub. Date: Jul. 9, 2026

(54) GENERATING MULTI-SUBJECT AND CUSTOMIZED MOTION VIDEOS

(71) Applicant: NVIDIA Corporation, Santa Clara, CA (US)

(72) Inventors: Fu-En Yang, Taipei City (TW); Yu-Chiang Frank Wang, Neihu District (TW); Chi-Pin Huang, Da'an Dist (TW)

(21) Appl. No.: 19/290,233

(22) Filed: Aug. 4, 2025

Related U.S. Application Data
(60) Provisional application No. 63/742,340, filed on Jan. 6, 2025.

(51) Int. Cl. G06T 11/00

(52) U.S. Cl. CPC G06T 11/00; G06T 2211/441

(57) ABSTRACT

The processes can generate customized text-to-video outputs focusing on producing high-quality videos that seamlessly incorporate specified identities and motion patterns. An appearance-agnostic motion learning approach can be used to leverage negative classifier-free guidance to disentangle underlying motion patterns from appearance features. To enable coherent and interactive multi-subject video generation, a spatial-temporal collaborative composition scheme that effectively integrates the learned multi-subject and motion LoRAs. This framework empowers the generation of high-quality videos that customize multiple subject identities and their respective interactive motions, addressing the limitations of conventional solutions and enhancing the flexibility and generalizability of text-to-video generation.

### CROSS-REFERENCE

This application claims the benefit of U.S. Provisional Application Ser. No. 63/742,340, filed by Fu-En Yang, et al., on Jan. 6, 2025, entitled “MULTI-SUBJECT AND MOTION CUSTOMIZATION OF TEXT-TO-VIDEO DIFFUSION MODELS,” commonly assigned with this application and incorporated herein by reference in its entirety.

### TECHNICAL FIELD

This application is directed, in general, to machine learning language models and, more specifically, to text-to-video diffusion models.

### BACKGROUND

Text-to-video models are machine learning (ML) models that generate videos based on an input text description. A text-to-video (TTV) diffusion model is an example of an ML model that uses a text description and generates a video using a diffusion process. A TTV diffusion model has a neural network architecture that is configured to generate data similar to tuning data that is used for training. The training data can include reference motion videos that are provided to the TTV diffusion model for motion learning. Customized text-to-video generation aims to produce high-quality videos that incorporate user-specified subject identities or motion patterns. Existing methods mainly focus on personalizing a single concept, either subject identity or motion pattern, limiting their effectiveness for multiple subjects with the desired motion patterns.

### SUMMARY

In one aspect, a text-to-video system is disclosed. In one embodiment, the text-to-video system includes (1) a subject learner configured to separately learn a token low-rank adaptation (LoRA) and a subject LoRA for each one of at least two subjects, using at least one image for each of the at least two subjects, (2) a motion learner configured to learn a motion LoRA for a motion pattern extracted from a reference motion video using a negative classifier-free guidance, and (3) a spatial-temporal collaborative composer configured to generate a video as an output using the token LoRAs, the subject LoRAs, and the motion LoRA, and to integrate the subject LoRAs and the motion LoRA using spatial-temporal collaborative sampling.

In a second aspect, a method is disclosed. In one embodiment, the method includes (1) receiving at least two images, at least one motion video, and a text prompt, wherein the at least two images are images of at least two different subjects and the at least one motion video shows a motion to be applied to the at least two different subjects, (2) learning a reference motion by applying an appearance-agnostic motion learning process to the at least one motion video guided by the text prompt, (3) applying a spatial-temporal algorithm to the at least two images, the reference motion, and the text prompt to compose an initial video of the at least two different subjects, and (4) generating an output video using the at least two different subjects from the initial video.

In a third aspect, a system is disclosed. In one embodiment, the system includes (1) a receiver configured to receive input parameters, wherein the input parameters include at least a text prompt, a set of images of two or more subjects, at least one reference motion video, and operation parameters, (2) a low-rank adaptation (LoRA) generator configured to generate one subject LoRA for each subject in the set of images and to generate a motion LoRA using the at least one reference motion video and an appearance-agnostic motion learning algorithm, and (3) one or more processors, configured to execute code to generate an output video using a spatial-temporal collaborative composition algorithm, the subject LoRAs, the motion LoRA, and the text prompt, wherein the spatial-temporal collaborative composition algorithm utilizes a diffusion model to add or subtract noise at each timestep of the output video.

In a fourth aspect, a non-transitory computer program product having a series of operating instructions stored on a non-transitory computer-readable medium that directs a data processing apparatus when executed thereby to perform operations is disclosed. In one embodiment, the operations include (1) receiving at least two images, at least one motion video, and a text prompt, wherein the at least two images are images of at least two different subjects and the at least one motion video shows a motion to be applied to the at least two different subjects, (2) learning a reference motion by applying an appearance-agnostic motion learning process to the at least one motion video guided by the text prompt, (3) applying a spatial-temporal algorithm to the at least two images, the reference motion, and the text prompt to compose an initial video of the at least two different subjects, and (4) generating an output video using the at least two different subjects from the initial video.

### BRIEF DESCRIPTION

Reference is now made to the following descriptions taken in conjunction with the accompanying drawings, in which:

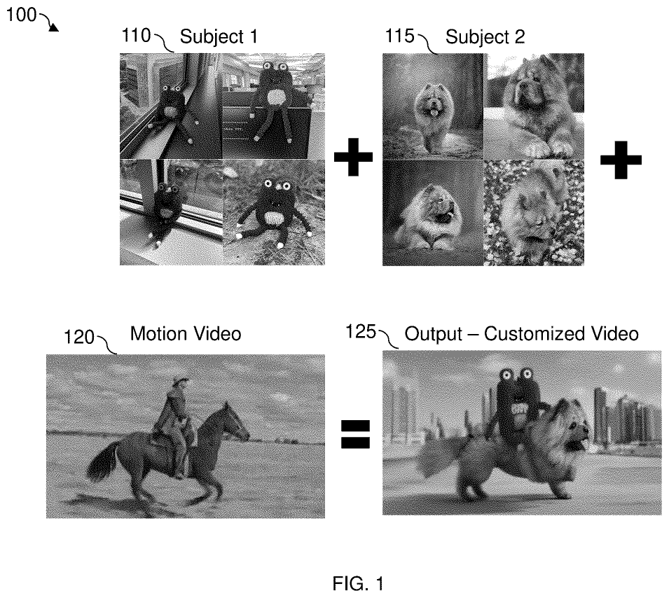

FIG. 1 is an illustration of a diagram of example images used as input parameters.

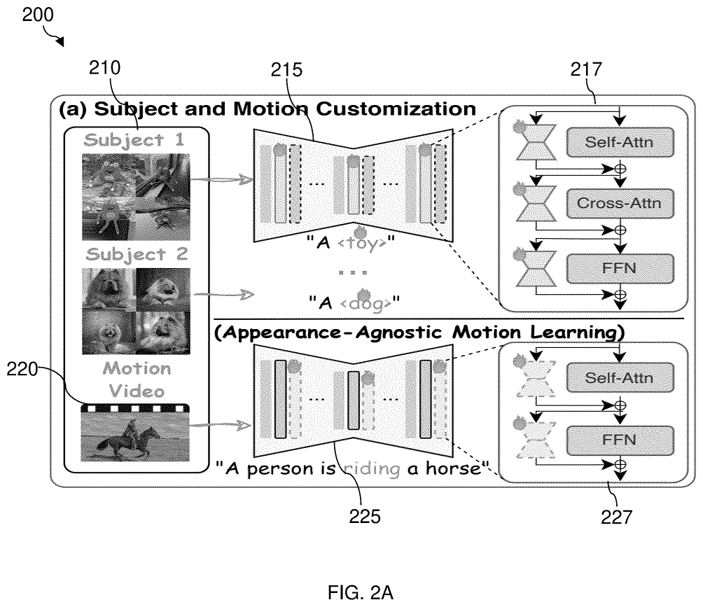

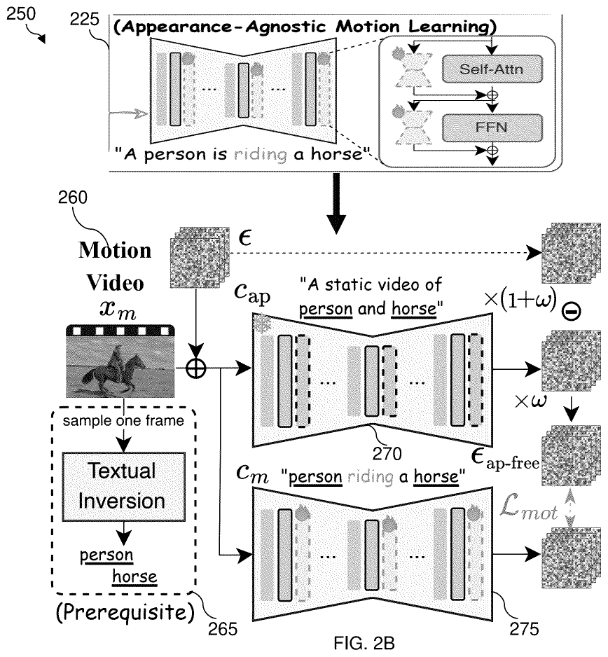

FIG. 2A is an illustration of a diagram of an example process for subject and motion customization;

FIG. 2B is an illustration of a diagram of an example process for appearance-agnostic motion learning;

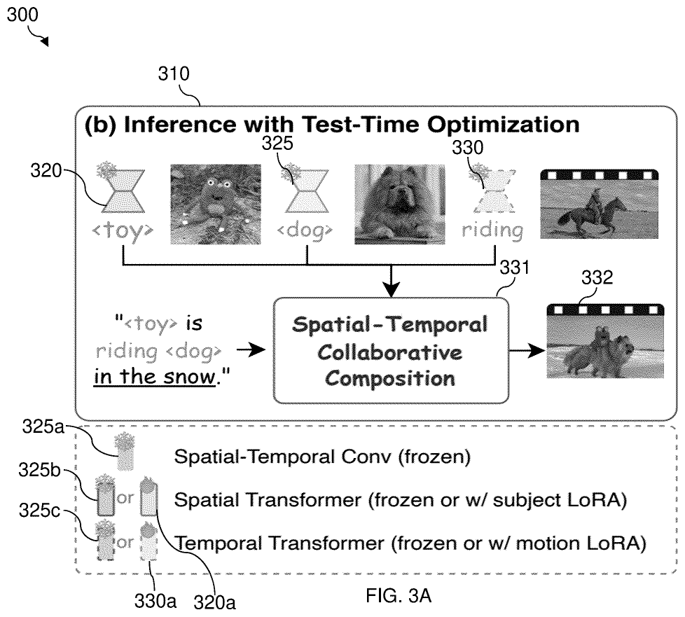

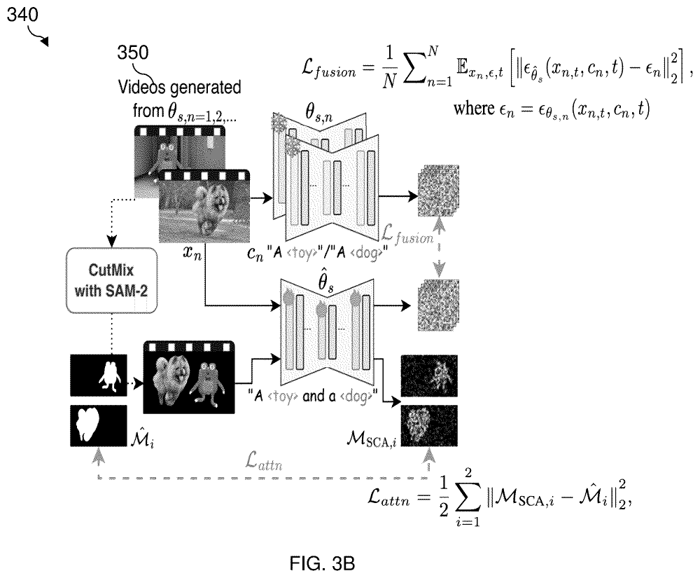

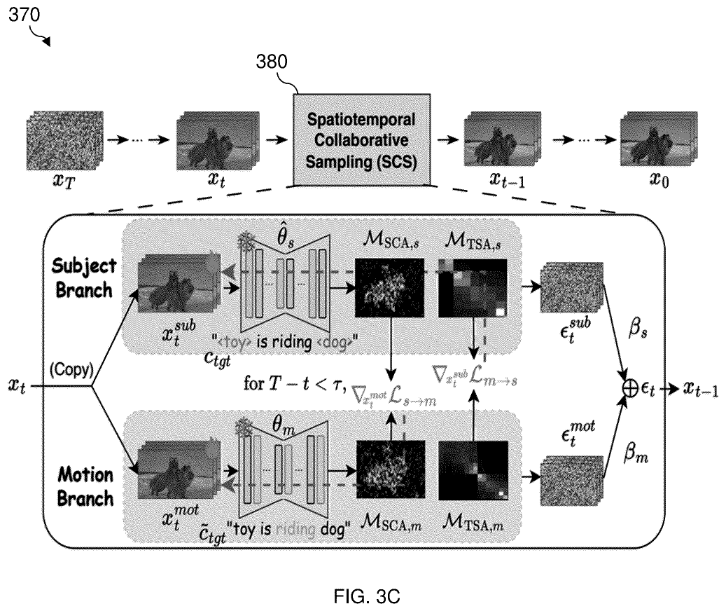

FIG. 3A is an illustration of a diagram of an example process for inference with test-time optimization;

FIG. 3B is an illustration of a diagram of an example process for fusion and attention;

FIG. 3C is an illustration of a diagram of an example process for subject and motion;

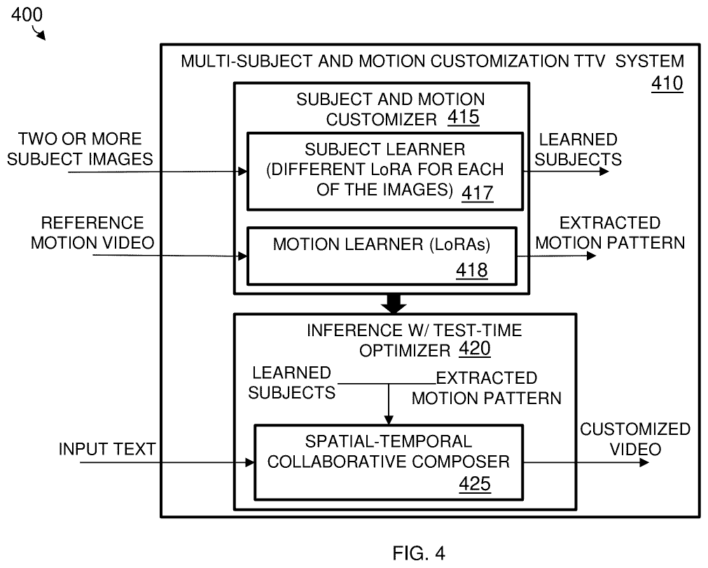

FIG. 4 is an illustration of a block diagram of an example multi-subject and motion customization text-to-video system;

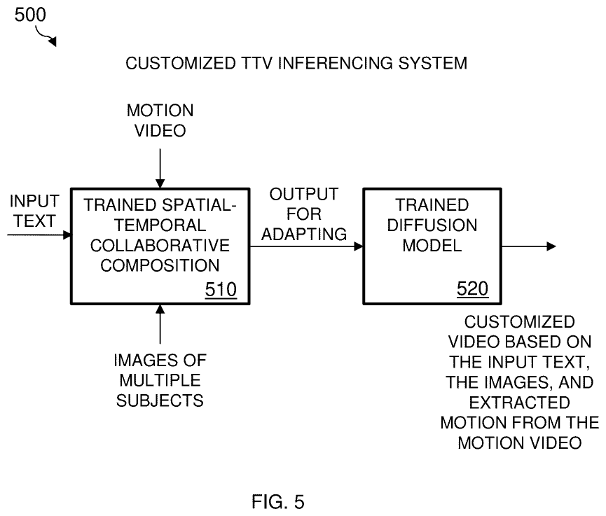

FIG. 5 is an illustration of a block diagram of an example text-to-video inferencing system;

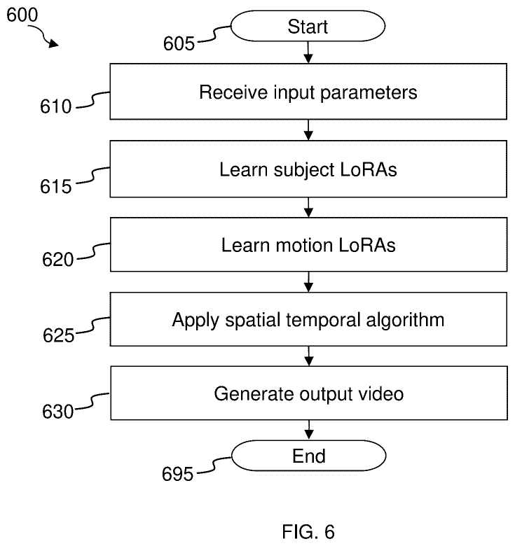

FIG. 6 is an illustration of a flow diagram of an example method to a unified framework for video content customization;

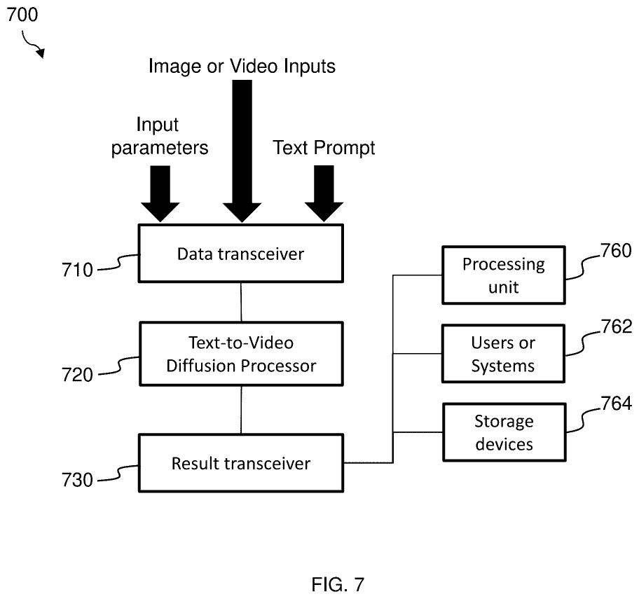

FIG. 7 is an illustration of a block diagram of an example TTV system; and

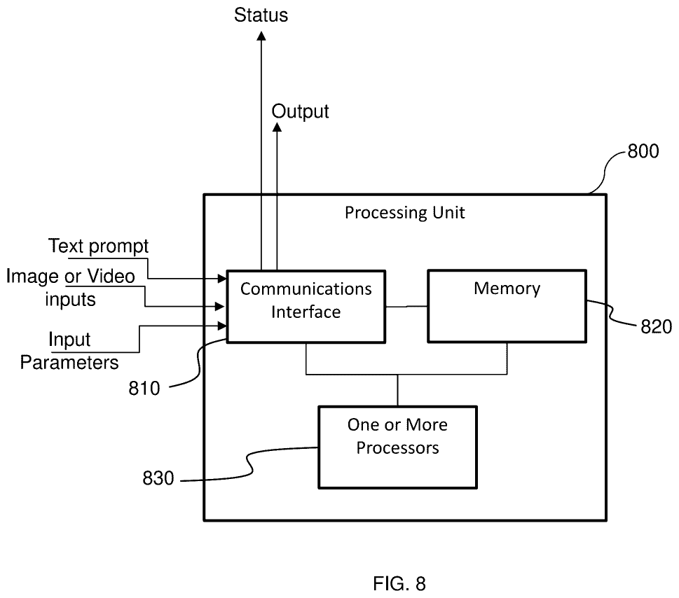

FIG. 8 is an illustration of a block diagram of an example of a TTV controller according to the principles of the disclosure.

### DETAILED DESCRIPTION

The use of diffusion models has greatly improved the generation of photorealistic videos from textual descriptions, enabling new possibilities for video content creation. While high-quality and diverse videos can now be synthesized, relying solely on text descriptions may lack precise control over desirable content that accurately aligns with the user intents.

To address this challenge, conventional solutions use customizing a desirable subject identity into synthesized videos. For example, some solutions animate the user-provided subject by tuning temporal modules inserted into the pre-trained image diffusion models. Some solutions employ cross-frame attention to preserve the fine-grained visual appearance of the customized subject. And some solutions fine-tune cross-attention layers on involved subjects simultaneously to customize multiple subjects within a scene. The conventional solutions use approaches that focus on the customization of the static subject. They are limited to offering users or video creators the ability to personalize their desired dynamic motions (e.g., specific dancing styles) into output videos, severely hampering the flexibility of video content customization.

To empower users with the controllability of dynamic motion, some solutions have designed modules to capture motion patterns from the conditioned reference videos. For instance, some solutions fine-tune low-rank adaptation (LoRA) inserted into temporal attention layers to learn the desired motion pattern. Similarly, some solutions employ LoRA to learn motion by using an objective that captures the differences between an anchor frame and the other frames. Simply tuning temporal modules while not properly disentangling motion information from reference videos can cause appearance leakage issues. This can result in derived motion patterns that cannot be applied with arbitrary subject identities. Without guidance for subjects and motion composition, these conventional solutions struggle to precisely control the interaction among these customized video concepts. As a result, the conventional solutions are limited in handling single (i.e., subject or motion) concept customization. Jointly customizing multiple video concepts by free-form prompts that describe multiple subjects and desired motion patterns would be beneficial.

Disclosed are processes that utilize a unified framework for video content customization, e.g., text-to-video (TTV), that enables controllability over subject identities and motion patterns. The disclosed processes involve subject and motion LoRAs to capture respective information from provided images or videos. The images or videos can be provided by a user through input parameters, from a system, a text-to-video library, a data store, or from other sources. In some aspects, a combination of images and videos can be provided. To reduce visual appearance contamination of the motion LoRAs, an appearance-agnostic motion learning algorithm can be used to isolate motion patterns from reference videos. More specifically, a negative classifier-free guidance algorithm conditioned on the visual appearance can be used, effectively disentangling motion from appearance details.

With the learned subject and motion LoRAs, a spatial-temporal collaborative composition algorithm to guide interactions among multiple subjects in the desired motion pattern can be used. Gradient-based fusion and spatial attention regularization can be used to absorb the multi-subject information while encouraging distinct spatial arrangements of subjects. By iteratively guiding the generation process using subject and motion LoRAs, the disclosed processes can synthesize output videos with enhanced user control and spatial-temporal coherence.

In some aspects, a unified framework can be used that first enables video concept customization for multiple subject identities and their interactive motion. In some aspects, an appearance-agnostic motion learning can be used by advancing negative classifier-free guidance to disentangle underlying motion patterns from appearance. In some aspects, a spatial-temporal collaborative composition scheme can be used to compose the obtained multi-subject and motion LoRAs for generating coherent multi-subject interactions in the desired motion pattern.

Given N subjects, each represented by a series of images (for example, 3-5 images) denoted as x_{s,i} for the i-th subject (omitting the individual image index for simplicity), a reference interactive motion video xₘ, and a provided text prompt c_{tgt}, the goal can be to generate a video based on c_{tgt} in which these N subjects interact according to the motion pattern. LoRA modules can be used to learn visual and motion information from input images and reference videos, respectively. Rather than using a naive combination, a spatial-temporal collaborative composition algorithm can be used to integrate the learned subjects and motion LoRAs for video generation (e.g., the output).

Video diffusion models (VDMs) are designed to generate video by gradually denoising a sequence of noises sampled from a Gaussian distribution. Specifically, the diffusion model ϵ_{θ} can learn to predict the amount of noise ϵ added or subtracted at each timestep t, conditioned on the input c, which is a text prompt in a text-to-video generation process. The training objective can be simplified to a reconstruction loss

$$ℒ = {𝔼}_{x , ϵ , t} [ {‖ {ϵ}_{θ} ( {x}_{t} , c , t ) - ϵ ‖}_{2}^{2} ] ,$$

where noise ϵ∈ [symbol] is sampled from N(0, I), timestep t∈U(0, 1), and xₜ=\sqrt{α̅ₜx}+1−\sqrt{α̅ₜϵ} is the noisy input at t, with α̅ₜ being a hyperparameter for controlling the diffusion process. To reduce computational cost, VDMs can encode the input video data x∈ [symbol] into a latent representation, e.g., derived by a variational autoencoder (VAE). For simplicity, in this disclosure, video data x is used as the model's input . . . .

To capture subject appearance for video generation, a specific token can be learned (e.g., “<toy>”), and a subject LoRA (Δθₛ) can be used to fine-tune the pre-trained video diffusion model. To avoid interfering with temporal dynamics, the subject LoRA can be applied to the spatial layers of the UNet. The objective can be defined as:

$${ℒ}_{sub} = {𝔼}_{{x}_{s} , ϵ , t} [ {‖ {ϵ}_{{θ}_{s}} ( {x}_{s , t} , {c}_{s} , t ) - ϵ ‖}_{2}^{2} ] ,$$

where xₛ∈ [symbol] is the subject image, θₛ=θ+Δθₛ denotes the parameters of the pre-trained model with the subject LoRA applied, and cₛ is the prompt containing the specific token (e.g., “a <toy>”).

Fine-tuning with image data alone might result in video diffusion models losing their capability to produce motion information. An auxiliary video dataset Dₐᵤₓ can be leveraged to regularize fine-tuning while preserving the pre-trained motion. More precisely, given video-caption pair (xₐᵤₓ, cₐᵤₓ) sampled from Dₐᵤₓ, the regularization loss is defined as:

$${ℒ}_{reg} = {𝔼}_{aux , ϵ , t} [ {‖ {ϵ}_{{θ}_{s}} ( {x}_{aux , t} , {c}_{aux} , t ) - ϵ ‖}_{2}^{2} ] .$$

The overall objective can be defined as [symbol] = [symbol] +λ₁ [symbol] , where λ₁ is the hyperparameter that controls the weight of the regularization loss. Optimizing this objective can capture the subject appearance while preserving the motion prior. With the training objective, customization for provided subject identities can be allowed while avoiding compromising the VDM's capability.

To learn the desired motion pattern from the reference video xₘ, a naïve strategy can be to fine-tune a motion LoRA and inject it into the UNet's temporal layers (i.e., Δθₘ). Direct applying the standard diffusion loss would result in an appearance leakage issue, wherein the motion LoRA inadvertently captures the appearance of subjects from the reference video. This entanglement of subject appearance and motion hinders the ability to apply the learned motion patterns to new subjects.

To address this problem, an appearance agnostic objective can be used, which can effectively isolate motion patterns from the reference video. Negative classifier-free guidance algorithm conditioned on the visual subject appearances can be used, focusing on removing appearance information during motion learning. This would help direct the motion LoRA to focus on motion dynamics. To achieve this, specific tokens can be learned for the subjects in the reference video (e.g., “person” or “horse”) by applying textual inversion on a single frame sampled from the reference video. This can capture subject appearance while minimizing motion influence, effectively decoupling appearance from motion. With the above specific tokens, a motion LoRA can be trained using an appearance agnostic objective that employs negative guidance to suppress appearance information, enabling the motion LoRA to learn motion patterns independently of subject appearances.

More specifically, the training objective can be defined as:

$${ℒ}_{mot} = {𝔼}_{{x}_{m} , ϵ , t} [ {‖ {ϵ}_{{θ}_{m}} ( {x}_{m , t} , {c}_{m} , t ) - {ϵ}_{ap - free} ‖}_{2}^{2} ]$$

where ϵ_{ap-free}=(1+ω)ϵ−ωϵ_{θ}(x_{m,t}, cₐₚ, t). ϵ_{ap-free} is the negatively guided appearance-free noise, ω is the hyperparameter controlling the guidance strength, and cₘ and cₐₚ describe the motion and the static subject appearances, respectively (e.g., “Person riding a horse” or “A static video of person and horse”). By optimizing this objective function, motion LoRA can learn motion patterns independent of subject appearances. This disentanglement can be important for composing multiple subjects with customized motions.

With multiple subject LoRAs and an interactive motion LoRA obtained, the goal can be to generate videos where these subjects interact using the desired motion pattern. Combining LoRAs with distinct properties (i.e., visual appearance vs. spatial-temporal motion) can be difficult. In some aspects, a test-time optimization scheme of spatial-temporal collaborative composition can be used, which enables collaboration between the LoRAs to generate videos with the desired appearance and motion properties.

In some aspects, the composition of multiple subject LoRAs can be implemented. A gradient-based fusion algorithm can be employed, such as using a subject fuser, to distill the distinct information, e.g., identities, from each subject LoRA into a single fused LoRA. That is, given multiple LoRAs, denoted as Δθ_{s,1}, Δθ_{s,2}, . . . , Δθ_{s,N}, where N is the number of subjects and each LoRA corresponds to a specific subject, the goal can be to learn a fused LoRA Δ [symbol] that can generate a video featuring the multiple subjects.

To achieve this, the fused LoRA Δ [symbol] can be enforced to generate consistent videos with each specific subject LoRA. Δ [symbol] can be optimized by matching the predicted amount of noise between the fused LoRA and the subject-specific one. The multi-subject fusion objective L_{fusion} can be formulated as

$${ℒ}_{fusion} = \frac{1}{N} {\sum }_{n = 1}^{N} {𝔼}_{{x}_{n} , ϵ , t} [ {‖ {ϵ}_{{\hat{θ}}_{s}} ( {x}_{n , t} , {c}_{n} , t ) - {ϵ}_{n} ‖}_{2}^{2} ] ,$$

where ϵₙ=ϵ_{θ}_{_{s,n}}(x_{n,t}, cₙ, t). Here, xₙ is the video generated by θ_{s,n}, and cₙ is the corresponding prompt for the n-th subject. To encourage different subject identities to be properly arranged, a spatial attention regularization algorithm [symbol] can be used to explicitly guide the model's attention to focus on the correct respective subject regions. Two subjects can be randomly sampled and segmented, such as by using Grounded-SAM2, and then the segmented subjects can be combined into a video. [symbol] can be defined as:

$${ℒ}_{attn} = \frac{1}{2} {\sum }_{i = 1}^{2} {‖ {ℳ}_{SCA , i} - {\hat{ℳ}}_{i} ‖}_{2}^{2} ,$$

where M_{SCA,i} is the spatial cross-attention map of the i-th sampled subject, and [symbol] is the corresponding ground-truth segmentation mask.

Therefore, the overall objective for deriving the multi-subject LoRA can be defined as: [symbol] = [symbol] +μ₂ [symbol] , where λ₂ controls the weight of the attention loss. In some aspects, multiple subjects are merged at once. Once the fused LoRA Δ [symbol] is obtained, videos can be generated with arbitrary motion patterns.

In some aspects, to integrate motion-based LoRA Δθₘ with the visual subject LoRAs Δ [symbol] , a spatial-temporal collaborative sampling (SCS) technique can be used to effectively control and guide the interactions among customized subjects. In SCS, the sampled noise from θₘ and [symbol] can be integrated. To encourage alignment during early timesteps, a collaborative guidance mechanism can be employed, where spatial and temporal attention maps from subject and motion models can be utilized to refine the other's input latents. This mutual alignment enables the branches to align effectively, resulting in a more coherent integration of subjects and their interaction. Pseudocode 1 is an example of an SCS algorithm.

```
Pseudocode 1: Example spatial-temporal collaborative sampling algorithm
Model: Pre-trained video diffusion model θ, fused multi-subject LoRA Δ\hat{θ}s, and motion
LoRA Δ\hat{θ}ₘ
Input: Target text prompt c_{tgt} (w/subjects' specific tokens)
Output: Sampled video x₀
for t = T, T − 1, ... , 1 do
  $duplicate {x}_{t} to create {x}_{t}^{sub} and {x}_{t}^{mot}$
  ${ϵ}_{t}^{sub} = {ϵ}_{{\hat{θ}}_{s}} ( {x}_{t}^{sub} , {c}_{tgt} , t ) \{ Subject branch noise \}$
  ${ϵ}_{t}^{mot} = {ϵ}_{{θ}_{m}} ( {x}_{t}^{mot} , {c}_{tgt} , t ) \{ Motion branch noise \}$
  if T − t < τ then
    /* Collaborative guidance */
    ${ℒ}_{s \to m} = {‖ {ℳ}_{SCA , s} - {ℳ}_{SCA , m} ‖}_{2}^{2}$
    ${ℒ}_{m \to s} = {‖ {ℳ}_{TSA , s} - {ℳ}_{TSA , m} ‖}_{2}^{2}$
    ${x}_{t}^{sub} := {x}_{t}^{sub} - {α}_{t} {∇}_{{x}_{t}^{sub}} {ℒ}_{m \to s}$
    ${x}_{t}^{mot} := {x}_{t}^{mot} - {α}_{t} {∇}_{{x}_{t}^{mot}} {ℒ}_{s \to m}$
    execute the subject branch noise and motion branch noise equations to
    $update {ϵ}_{t}^{sub} and {ϵ}_{t}^{mot} ( an amount of noise can be added or subtracted )$
end if
${ϵ}_{t} = {β}_{s} {ϵ}_{t}^{sub} + {β}_{m} {ϵ}_{t}^{mot} and obtain {x}_{t - 1}$
end for
return x₀
```

In some aspects, given a noised video input xₜ, it can be duplicated into

$${x}_{t}^{sub} and {x}_{t}^{mot}$$

for the subject and motion branches. With Δ [symbol] and θₘ denoting the models with the fused LoRA and the motion LoRA applied, respectively, appearance noise

$$( {ϵ}_{t}^{sub} )$$

and motion noise

$$( {ϵ}_{t}^{mot} )$$

can be generated as

$${ϵ}_{t}^{sub} = {ϵ}_{{\hat{θ}}_{s}} ( {ϵ}_{t}^{sub} , {c}_{tgt} , t ) and {ϵ}_{t}^{mot} = {ϵ}_{{\hat{θ}}_{m}} ( {ϵ}_{t}^{mot} , {\tilde{c}}_{tgt} , t ) ,$$

where c_{tgt} is the input prompt containing subject specific tokens (e.g., “A <toy> is riding a <dog>”), and \tilde{c}_{tgt} is constructed by replacing the specific tokens of the original text prompt with their respective superclasses (e.g., “A toy is riding a dog”).

Direct combination of subject and motion noises (e.g., via an add or subtract operation) for inference might result in information leakage from either modality. The spatial cross-attention map, M_{SCA}, corresponding to subject tokens can capture the spatial arrangement of subjects, while the temporal self-attention map, M_{TSA}, across the frames can capture the frame-wise dependencies, representing motion dynamics. When observing a text prompt c_{tgt} during inference, [symbol] and θₘ can be encouraged to produce aligned noisy video outputs.

Since the subject branch has subject LoRA, it can generate incorrect motion. Motion correctness can be enforced by aligning the temporal self-attention map with that of the motion branch. Similarly, for the motion branch, the spatial cross-attention maps can be aligned with those of the subject branch to ensure proper spatial arrangements of the subjects. As a result, losses for cross-modal alignment can be calculated as

$${ℒ}_{s \to m} = {‖ {ℳ}_{SCA , s} - {ℳ}_{SCA , m} ‖}_{2}^{2} and {ℒ}_{m \to s} = {‖ {ℳ}_{TSA , s} - {ℳ}_{TSA , m} ‖}_{2}^{2} ,$$

where the subscripts s and m indicate that the maps are from the subject and motion branches, respectively.

$${x}_{t}^{sub} and {x}_{t}^{mot}$$

can be updated as

$${x}_{t}^{sub} := {x}_{t}^{sub} - {α}_{t} {∇}_{{x}_{t}^{sub}} {ℒ}_{m \to s} and {x}_{t}^{mot} := {x}_{t}^{mot} - {α}_{t} {∇}_{{x}_{t}^{mot}} {ℒ}_{s \to m} ,$$

where αₜ is the step size of the gradient update. This guidance is applied for the first τ denoising steps, where τ is a hyperparameter. The predicted amount of noise can be calculated by

$${ϵ}_{t} = {β}_{s} {ϵ}_{t}^{sub} + {β}_{m} {ϵ}_{t}^{mot}$$

where βₛ=βₘ=0.5 for simplicity (where noise can be subtracted by using a negative amount).

Turning now to the figures, FIG. 1 is an illustration of a diagram of example images 100 used as input parameters. Images 100 has a first set of images 110 showing a first subject of a doll. First set of images 110 can have one or more images. A second set of images 115 shows a second subject of a dog. Second set of images 115 can have one or more images. In some aspects, more than two subjects can be provided as input parameters. In some aspects, each subject can have a different number of images in its corresponding set of images.

A reference motion video 120 shows a man riding a horse. The appearance-agnostic algorithm can be applied to reference motion video 120 to capture the motion elements of subject ‘A’ riding on the back of subject ‘B’, where the concepts of a man and a horse are removed from the motion trajectories that are captured. In some aspects, more than one reference motion video can be provided in the input parameters. An output video 125 shows the generated video of the first subject riding on top of the second subject.

FIG. 2A is an illustration of a diagram of an example process 200 for subject and motion customization. Process 200 shows an overview of part of the disclosed processes. Given images of multiple subjects and a reference video with desirable motion, the disclosed processes advance LoRAs to capture the knowledge of visual appearances and appearance-agnostic motion information. Process 200 has two subjects 210 as input parameters. The appearance of the subjects 210 can be captured by learning a specific token, for example, toy, doll, pet, dog, or other appropriate specific token.

The multiple subject LoRAs (one for each subject) can be determined and used in fine-tuning the pre-trained video diffusion model, such as in a process 215. In some aspects, the multiple subject LoRAs can be fused into one fused LoRA before being integrated with the motion LoRA, such as in process 215. The subject LoRAs can be represented by LoRA 217, which shows self-attention features being captured, cross-attention features being captured, and feed-forward network (FFN) features being captured.

A reference motion video 220 is shown as an input parameter. Reference motion video 220 can be analyzed by an appearance-agnostic motion learning algorithm 225 to remove appearance bias in the video generation. For example, this process can change “a man riding a horse” to “subject A riding subject B”. The motion LoRA can be represented by LoRA 227, which shows self-attention features being captured and FFN features being captured.

FIG. 2B is an illustration of a diagram of an example process 250 for appearance-agnostic motion learning. Appearance-agnostic motion learning algorithm 225 can be further demonstrated by block algorithm 260. Reference motion video 220 can be processed by a textual inversion algorithm 265 to determine the tokens to use in further processing. The textual inversion process can be applied to at least one frame of the reference motion video. In this example, the tokens identified are “person” and “horse”. By utilizing the text prompt emphasizing the token (e.g., appearance information, i.e., cₐₚ, the appearance-agnostic motion information can be extracted using the negative classifier-free guidance. Process 270 can track the token information, e.g., the appearance of the subjects of the video. Process 275 can track the motion of the tokens through each timestep of the reference motion video. The results of process 270 can be used to remove the appearance information from the results of process 275, thereby implementing the negative classifier-free guidance algorithm.

FIG. 3A is an illustration of a diagram of an example process 300 for inference with test-time optimization 310. Process 300 can utilize the text prompt relating to the visual and motion concepts with the spatial-temporal collaboration composer to refine the noisy latent information for generating a video matching the desirable visual and motion information. A subject LoRA 320 can be combined with a subject LoRA 325 and a motion LoRA 330 using a spatial-temporal collaborative composer 331 to generate the output video 332.

Subject LoRA 325 can utilize various frameworks. For example, diagram key 325a indicates that subject LoRA 325 can utilize a spatial-temporal conversion that is frozen, e.g., the model parameters are not updated. Diagram key 325b indicates that subject LoRA 325 can utilize a spatial transformer that is frozen or with a subject LoRA. Diagram key 325c indicates that subject LoRA 325 can utilize a temporal transformer that is frozen or with a motion LoRA. Diagram key 320a indicates that subject LoRA 320 can utilize a spatial transformer that is frozen or with a subject LoRA. Diagram key 330a indicates that motion LoRA 330 can utilize a temporal transformer that is frozen or with a motion LoRA.

FIG. 3B is an illustration of a diagram of an example process 340 for fusion and attention. Process 340 represents a demonstration of the algorithm for spatial-temporal collaborative composition for text-to-video test-time optimization. Algorithm 350 shows a test-time fusion of subject LoRAs \hat{θ}ₛ, which employs attention regularization [symbol] to ensure appearance preservation of each visual subject. Algorithm 350 demonstrates a random sample and segment of two subjects. The two segmented subjects are then combined into a video.

FIG. 3C is an illustration of a diagram of an example process 370 for subject and motion analysis. Process 370 demonstrates a spatial-temporal collaboration sampling integrating the fused LoRA \hat{θ}ₛ and the motion LoRA θₘ by cross-modal alignment, improving visual and temporal coherence. Process 370 can use as input a noised video which can be segmented into a subject portion and a motion portion at each timestep.

Process 370 utilizes a spatial-temporal collaborative sampling process 380 and can generate an appearance noise for the subject and motion noise for the motion. Motion correctness can be enforced on the subject branch by aligning the temporal self-attention map with those of the motion branch. Process 370 works the other path as well to maintain appropriate cross alignment, meaning, for the motion branch, the spatial cross-attention maps can be aligned with those of the subject branch to improve the spatial arrangements of the subjects.

FIG. 4 is an illustration of a block diagram of an example text-to-video system 400 for multi-subject and motion customization. Text-to-video system 400 has a multi-subject and motion customization TTV system 410 that can execute code to implement the disclosed processes. A subject and motion customizer 415 includes a subject learner 417 that can receive two or more subject images of at least two different subjects. A subject LoRA can be trained for each subject identified in the images. A motion learner 418 can receive one or more reference motion videos. A motion LoRA can be trained for each received video. An appearance-agnostic algorithm can be applied to extract the motion patterns from the reference motion videos.

During training, parameters for the LoRAs used in the subject and motion learners can be learned during the subject and motion customization and used for the spatial-temporal collaborative composition. Once trained, a trained model can be used with a diffusion model to generate a desired multi-subject and motion-customized video. An inference optimizer 420 can receive the text prompt (e.g., input text) and apply the subject and motion LoRAs to a spatial-temporal collaborative composer 425 to generate the output video.

FIG. 5 is an illustration of a block diagram of an example text-to-video inferencing system 500. Text-to-video inferencing system 500 has a trained model 510 that can receive a reference video, images of subjects, and a text prompt. Trained model 510 can output a video along with the input parameters and interim processing results. This combined information can be used as an input to a trained diffusion model 520. Trained diffusion model 520 can be stored, such as in a text-to-video library or a machine learning system, to be used by future requests to generate videos.

FIG. 6 is an illustration of a flow diagram of an example method 600 to a unified framework for video content customization. Method 600 can be performed on a computing system, for example, TTV system 700 of FIG. 7 or TTV controller 800 of FIG. 8. The computing system can be one or more processors in various combinations (e.g., CPUs, GPUs, SIMDs, or other types of processors), a data center, a cloud environment, a server, a laptop, a mobile device, a smartphone, a PDA, or other computing system capable of receiving the thread requests, and capable of executing threads in parallel. Method 600 can be encapsulated in software code or hardware, for example, an application, code library, code module, dynamic link library, module, function, RAM, ROM module, and other software and hardware implementations. The software can be stored in a file, database, or other computing system storage mechanism. Method 600 can be partially implemented in software and partially in hardware. Method 600 can perform the steps for the described processes, for example, determining the subject and motion LoRAs and using the LoRAs to generate the output video in response to the text prompt.

Method 600 starts at a step 605 and proceeds to a step 610. In step 610, input parameters can be received. The input parameters can include specified algorithms to use at each step of the process, for example, a fusing algorithm to use in aspects where subject LoRAs are combined. The fusing algorithm can be additive or use other combining algorithms. The input parameters can specify various threshold parameters, such as a convergence threshold parameter, a quality threshold parameter, or other threshold parameters. The input parameters can include two or more subject images of at least two different subjects. The subject images can be images, frames taken from a subject video, drawings, paintings, pictures, or other visual forms. Each subject should have at least one image. Each subject can have a different number of images from other subjects in the set of images, representing that subject. The input parameters can include at least one reference motion video. The input parameters can include operation parameters to direct the operation of the method or system.

In some aspects, the subject images or the reference motion video can be sourced from a machine learning system. In some aspects, a text-to-video library of subject images or reference motion videos can be used. In some aspects, previously trained output videos can be used, along with the respective subject LoRAs and motion LoRA associated with the previously trained output videos.

The input parameters can include a text prompt used to guide the generation of the output video. In some aspects, the text prompt can be reconstructed by replacing specific tokens with their respective superclasses, and the text prompt can then be used to generate an appearance noise parameter and a motion noise parameter used by the spatial-temporal algorithm.

In a step 615, the subject LoRAs can be learned from the set of subject images received. The process uses at least two distinct subjects from the set of subject images. In some aspects, the subject LoRAs can be fused (e.g., combined) using a fusing algorithm (such as one fused LoRA). In some aspects, at least one subject LoRA is a pre-trained model.

In a step 620, the motion LoRA can be learned from the reference motion video. The reference motion video is processed using an appearance-agnostic motion learning process. In some aspects, a negative classifier-free guidance algorithm that is conditioned on the visual appearance of subjects in the reference motion video to disentangle motion from the appearance details. In some aspects, the motion LoRA learning can be guided by the text prompt to focus the learning on the appropriate subjects of the reference motion video that are important to the text prompt. In some aspects, a fine-tuning algorithm can be applied to the motion LoRA. For example, a fine-tuner can be used to improve the video using an auxiliary video dataset to regularize a fine-tuning process while preserving the pre-trained motions. In some aspects, a motion feature extractor can be used to perform the appearance-agnostic motion learning algorithm using motion feature matching to train the motion LoRA, and to provide to the one or more processors extracted spatial-temporal motion trajectories from cross-attention motion dynamics and inter-frame motion dynamics from temporal self-attention maps.

In a step 625, a spatial-temporal algorithm can be applied to at least two images in the set of subject images using the respective subject LoRAs, the motion LoRA, and the text prompt to compose an initial video. In some aspects, the spatial-temporal algorithm can be performed iteratively using the subject LoRAs and the motion LoRA until a convergence threshold is satisfied. In some aspects, the spatial-temporal algorithm can utilize a gradient-based fusion and spatial attention regularization that absorbs information from the at least two images and uses distinct spatial arrangements of the at least two different subjects (such as using a subject fuser). In some aspects, the spatial-temporal collaborative composition can generate the output using a collaborative guidance mechanism to align a spatial attention map and a temporal attention map from each of the subject LoRAs and motion LoRAs, where the spatial attention map and temporal attention map from the subject LoRAs are used as input latents into the motion LoRAs, and the spatial attention map and temporal attention map from the motion LoRAs are used as input latents into the subject LoRAs.

In a step 630, the output video can be generated using the subject LoRAs, the motion LoRA, and the results of the spatial-temporal algorithm, guided by the text prompt. The output video (e.g., the result), can be communicated to a user, a data store, used as training for a machine learning system, or stored in a TTV library. In some aspects, for example, at least one image for each of the subjects are training images, the reference motion video is a training motion video, and the text prompt is training text, and the training images, the training motion video, the training text, and the output are stored in a TTV library or a machine learning system. In another aspect, the video, the text prompt, the subject LoRAs, and the motion LoRA can be added as training data, where the video can be used as a new reference motion video for a different set of input parameters. Method 600 ends at a step 695.

FIG. 7 is an illustration of a block diagram of an example TTV system 700. TTV system 700 can be implemented in one or more computing systems or one or more processors. In some aspects, TTV system 700 can be implemented using a TTV controller such as TTV controller 800 of FIG. 8. TTV system 700 can implement one or more aspects of this disclosure, such as method 600 of FIG. 6.

TTV system 700, or a portion thereof, can be implemented as an application, a code library, a dynamic link library, a function, a module, a header file, other software implementations, or combinations thereof. In some aspects, TTV system 700 can be implemented in hardware, such as a ROM, a graphics processing unit, or other hardware implementations. In some aspects, TTV system 700 can be implemented partially as a software application and partially as a hardware implementation. TTV system 700 is a functional view of the disclosed processes, and an implementation can combine or separate the functions in one or more software or hardware systems.

TTV system 700 includes a data transceiver 710, a TTV diffusion processor 720, and a result transceiver 730. The output, e.g., the response to the text prompt, can be communicated to a data receiver as a result, such as to one or more of a processing system 760 (one or more combinations of processors, or processing cores), one or more users or systems 762, or one or more storage devices 764 (such as a learning library). The output can be used to present a response to a user, stored for future use, used as a reference motion video for other text prompts, or used as an input into other processing systems or machine learning systems.

In some aspects, the results of TTV diffusion processor 720, such as those communicated to one or more of processing system 760, one or more storage devices 764, or one or more users or systems 762, can be used as input into another process or system, such as a machine learning system. The results can be used for further processing, such as for input into artificial intelligence learning, for validation of other system processes, or real-world applications, such as producing a video using the input parameters.

Data transceiver 710 can receive the input parameters. The input parameters can include algorithms to use, such as the fusing algorithm to implement when combining subject LoRAs, various threshold parameters (e.g., a convergence threshold parameter, or other threshold parameters), and other operational parameters. The input parameters can include a text prompt describing the request. The input parameters can include two or more images of subjects and at least one reference motion video. In some aspects, data transceiver 710 can be part of TTV diffusion processor 720.

Result transceiver 730 (e.g., a transmitter) can communicate one or more outputs (e.g., results), to one or more data receivers, such as one or more of processing system 760, one or more users or systems 762, storage devices 764, or other related systems, whether proximate result transceiver 730 or distant from result transceiver 730. Data transceiver 710, TTV diffusion processor 720, and result transceiver 730 can be, or can include, conventional interfaces configured for transmitting and receiving data. Data transceiver 710, TTV diffusion processor 720, or result transceiver 730 can be implemented as software components, for example, a virtual processor environment, as hardware, for example, circuits of an integrated circuit, or combinations of software and hardware components and functionality. The functionality described for these components remains intact regardless of how the functionality is implemented.

TTV diffusion processor 720 (e.g., one or more processors such as processor 830 of FIG. 8) can implement the analysis and algorithms as described herein, utilizing the input parameters. TTV diffusion processor 720 can execute code to implement a generation of the subject LoRAs, a generation of the motion LoRAs, an application of a spatial-temporal algorithm to the LoRAs, execute code to implement other models and processes, or various combinations thereof. TTV diffusion processor 720 can be one or more of a multicore processor, a multiprocessor system, or a streaming multiprocessor. TTV diffusion processor 720 can be implemented by a central processor unit (CPU), a graphics processor unit (GPU), or other types of processors. In some aspects, TTV diffusion processor 720 can be a non-transitory computer program product having a series of operating instructions stored on a non-transitory computer-readable medium that directs a video processing apparatus, when executed thereby to perform operations as disclosed herein. In some aspects, TTV diffusion processor 720 can be a non-transitory computer-readable medium having a series of operating instructions that directs a video processing apparatus, when executed thereby to perform the operations.

A memory or data storage system of TTV diffusion processor 720 (such as a core cache, L1 cache, L2 cache, or other memory systems) can be configured to store the processes and algorithms for directing the operation of TTV diffusion processor 720. TTV diffusion processor 720 can include a processor that can be configured to operate according to the analysis operations and algorithms disclosed herein, and an interface to communicate (transmit and receive) data.

FIG. 8 is an illustration of a block diagram of an example of a TTV controller 800 according to the principles of the disclosure. TTV controller 800 can be stored on one computer or multiple computers. The various components of TTV controller 800 can communicate via wireless or wired conventional connections. A portion or a whole of TTV controller 800 can be located at one or more locations. In some aspects, TTV controller 800 can be part of another system (e.g., processor, core, server, or other systems), and can be integrated with one device, such as a part of a processing system. TTV controller 800 represents a demonstration of the functionality employed for the disclosure, and implementations can use a variety of devices, for example, circuits of a processor, dedicated processors, virtual systems, servers, other computing or processing systems, in software or hardware, or various combinations thereof.

TTV controller 800 can be configured to perform the various functions disclosed herein including receiving input parameters, text prompts, subject images, and reference motion videos, and generating results (e.g., prompt responses, statuses) from the execution of the methods and processes described herein, such as determining the subject and motion LoRAs, applying appearance-agnostic algorithms, and applying spatial-temporal combination processes to generate an output responding to the text prompt. TTV controller 800 includes a communications interface 810, a memory 820, and a processor 830.

Communications interface 810 can be configured to transmit and receive data. For example, communications interface 810 can receive the input parameters, including the text prompt, the images, and the reference videos. Communications interface 810 can transmit the output or interim outputs. In some aspects, communications interface 810 can transmit a status, such as a success or failure indicator of TTV controller 800 regarding receiving the various inputs, transmitting the generated outputs, or producing the results.

In some aspects, processor 830 can perform the operations as described by TTV diffusion processor 720. Communications interface 810 can communicate via the communication systems used in the industry. For example, wireless or wired protocols can be used. Communication interface 810 can perform the operations as described for data transceiver 710 and result transceiver 730 of FIG. 7.

Memory 820 can be configured to store a series of operating instructions that direct the operation of processor 830 when initiated, including supporting code representing the algorithm for determining the respective LoRAs and using the LoRAs to generate a video using spatial-temporal processes. Memory 820 can be a non-transitory computer-readable medium. Multiple types of memory can be used for the data storage systems and memory 820 can be distributed.

Processor 830 can be one or more processors. Processor 830 can be a combination of processor types, such as a CPU, a GPU, a single instruction multiple data (SIMD) processor, or other processor types. Processor 830 can be configured to produce the output, one or more interim outputs, and statuses utilizing the received inputs. Processor 830 can determine the output using parallel processing. Processor 830 can be an integrated circuit. In some aspects, processor 830, communications interface 810, memory 820, or various combinations thereof, can be an integrated circuit. Processor 830 can be configured to direct the operation of TTV controller 800. Processor 830 includes the logic to communicate with communications interface 810 and memory 820, and perform the functions described herein. Processor 830 can be capable of performing or directing the operations as described by TTV diffusion processor 720 of FIG. 7.

For example, in some aspects, TTV system 700 or TTV controller 800 can perform as a subject learner configured to separately learn a token low-rank adaptation (LoRA) and a subject LoRA for each one of at least two subjects using at least one image for each of the at least two subjects, a motion learner configured to learn a motion LoRA for a motion pattern extracted from a reference motion video using a negative classifier-free guidance, and a spatial-temporal collaborative composer configured to generate a video as an output using the token LoRAs, the subject LoRAs, and the motion LoRA, and to integrate the subject LoRAs and the motion LoRA using spatial-temporal collaborative sampling. In some aspects, TTV system 700 or TTV controller 800 can be part of another system that receives the input parameters. For example, in some aspects, TTV system 700 or TTV controller 800 can be part of a machine learning system, an artificial intelligence (AI) generative tool, or can be in a data center, a cloud system, an edge system, a corporate system, or other type of system or location. In some aspects, TTV system 700 or TTV controller 800 can be part of a machine learning system, where TTV diffusion processor 720 can be part of the machine learning processes. In some aspects, TTV system 700 or TTV controller 800 can implement a non-transitory computer program product having a series of operating instructions stored on a non-transitory computer-readable medium that directs a data processing apparatus, when executed thereby to perform operations, the operations comprising the steps described herein for this disclosure, such as method 600 of FIG. 6. In some aspects, TTV system 700 or TTV controller 800 can implement a non-transitory computer-readable medium having a series of operating instructions that directs a data processing apparatus, when executed thereby to perform the operations.

A portion of the above-described apparatus, systems, or methods can be embodied in or performed by various digital data processors or computers, wherein the computers are programmed or store executable programs of sequences of software instructions to perform one or more of the steps of the methods. The software instructions of such programs can represent algorithms and be encoded in machine-executable form on non-transitory digital data storage media, e.g., magnetic or optical disks, random-access memory (RAM), magnetic hard disks, flash memories, or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs can be included on a graphics card that includes one or more memory devices and is configured to interface with the motherboard of a computer. The GPUs can be integrated GPUs (iGPUs) that are co-located with a CPU on one chip. Configured or configured to means, for example, designed, constructed, or programmed, with the necessary logic or features for performing a task or tasks. The processors or computers can be part of GPU racks located in a data center. The GPU racks can be high-density (HD) GPU racks that include high-performance GPU compute nodes and storage nodes. The high-performance GPU compute nodes can be servers designed for general-purpose computing on graphics processing units (GPGPU) to accelerate deep learning applications. For example, the GPU compute nodes can be servers of the DGX product line from NVIDIA Corporation of Santa Clara, California.

The compute density provided by the HD GPU racks is advantageous for AI computing and GPU data centers directed to AI computing. The HD GPU racks can be used with reactive machines, autonomous machines, self-aware machines, and self-learning machines that all require a massive compute-intensive server infrastructure. For example, the GPU data centers employing HD GPU racks can provide the storage and networking needed to support large-scale neural network (NN) training, such as for the NNs disclosed herein used for neural motion planners. The NNs can be Deep Neural Networks (DNN).

The NNs disclosed herein include multiple layers of connected nodes that can be trained with input data to solve complex problems. For example, contextual data, UPC, proposed trajectories, or a combination thereof can be used as input data for training of the NN. Once the NNs are trained, the NNs can be deployed and used to generate planned trajectories.

In one example of training, data flows through the NNs in a forward propagation phase until a prediction is produced that indicates a label corresponding to the input. When the NNs do not correctly label the input, errors between the correct label and the predicted label are analyzed, and the weights are adjusted for features of the layers during a backward propagation phase that correctly labels the inputs in a training dataset. With thousands of processing cores that are optimized for matrix math operations, GPUs such as those noted above are capable of delivering the performance required for training NNs for artificial intelligence and machine learning applications.

Portions of disclosed examples or embodiments can relate to computer storage products with a non-transitory computer-readable medium that have program code thereon for performing various computer-implemented operations that embody a part of an apparatus, device, or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Configured or configured to means, for example, designed, constructed, or programmed, with the necessary logic or features for performing a task or tasks. Examples of program code include machine code, such as produced by a compiler, and files containing higher-level code that can be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, utilized, or combined with other elements, components, or steps that are not expressly referenced.

Those skilled in the art to which this application relates will appreciate that other and further additions, deletions, substitutions, and modifications can be made to the described embodiments. It is also to be understood that the terminology used herein is to describe particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein. Additional material is also submitted herewith.

Each one of the aspects of the Summary can have one or more of the features of the below dependent claims in combination.

What is claimed is:

1. A text-to-video system, comprising:
a subject learner configured to separately learn a token low-rank adaptation (LoRA) and a subject LoRA for each one of at least two subjects, using at least one image for each of the at least two subjects;
a motion learner configured to learn a motion LoRA for a motion pattern extracted from a reference motion video using a negative classifier-free guidance; and
a spatial-temporal collaborative composer configured to generate a video as an output using the token LoRAs, the subject LoRAs, and the motion LoRA, and to integrate the subject LoRAs and the motion LoRA using spatial-temporal collaborative sampling.

2. The text-to-video system as recited in claim 1, further comprising:
a subject fuser configured to fuse at least two of the subject LoRAs using a gradient-based fusion algorithm to distill distinct information from each of the at least two of the subject LoRAs into one fused LoRA, and the spatial-temporal collaborative composer utilizes the fused LoRA.

3. The text-to-video system as recited in claim 2, wherein the spatial-temporal collaborative composer utilizes a spatial attention regularization algorithm to guide focus on respective subject regions of the at least two subjects.

4. The text-to-video system as recited in claim 1, wherein the motion learner is configured to learn the motion LoRA independent of an appearance of a subject within the reference motion video using a negative classifier-free guidance algorithm conditioned on a visual appearance of the at least two subjects, where the negative classifier-free guidance removes appearance information during motion learning.

5. The text-to-video system as recited in claim 1, wherein the spatial-temporal collaborative composer is configured to generate the output using a collaborative guidance mechanism to align a spatial attention map and a temporal attention map from each of the subject LoRAs and the motion LoRAs, wherein the spatial attention map and temporal attention map from the subject LoRAs are used as input latents into the motion LoRAs, and the spatial attention map and the temporal attention map from the motion LoRAs are used as input latents into the subject LoRAs.

6. The text-to-video system as recited in claim 1, wherein the spatial-temporal collaborative composer is configured to generate the video using a text prompt that corresponds to the at least two subjects and the reference motion video.

7. The text-to-video system as recited in claim 6, wherein the at least one image for each of the at least two subjects are training images, the reference motion video is a training motion video, and the text prompt is training text, where the training images, the training motion video, the training text, and the output are stored in a text-to-video library or a machine learning system.

8. The text-to-video system as recited in claim 7, wherein at least one subject LoRA from the at least two subjects is a pre-trained model.

9. The text-to-video system as recited in claim 1, wherein the subject learner, the motion learner, and the spatial-temporal collaborative composer are part of a machine learning system.

10. The text-to-video system as recited in claim 1, wherein the spatial-temporal collaborative composer utilizes a diffusion model, conditioned on a text prompt, to predict an amount of noise to be added or subtracted at each timestep of the video.

11. The text-to-video system as recited in claim 1, further comprising:
a fine-tuner configured to improve the video using an auxiliary video dataset to regularize a fine-tuning process while preserving pre-trained motions.

12. A method, comprising:
receiving at least two images, at least one motion video, and a text prompt, wherein the at least two images are images of at least two different subjects and the at least one motion video shows a motion to be applied to the at least two different subjects;
learning a reference motion by applying an appearance-agnostic motion learning process to the at least one motion video guided by the text prompt;
applying a spatial-temporal algorithm to the at least two images, the reference motion, and the text prompt to compose an initial video of the at least two different subjects; and
generating an output video using the at least two different subjects from the initial video.

13. The method as recited in claim 12, wherein at least one of the at least two images are sourced from a frame of a subject video.

14. The method as recited in claim 12, wherein the at least two images or the at least one motion video are sourced from a machine learning system.

15. The method as recited in claim 12, wherein the at least two images are provided through input parameters.

16. The method as recited in claim 12, wherein the appearance-agnostic motion learning process utilizes a negative classifier-free guidance algorithm conditioned on a visual appearance to disentangle motion from appearance details.

17. The method as recited in claim 12, wherein the spatial-temporal algorithm utilizes a gradient-based fusion and spatial attention regularization that absorbs information on the at least two images and uses distinct spatial arrangements of the at least two different subjects.

18. The method as recited in claim 12, wherein the applying the spatial-temporal algorithm is performed iteratively using a subject low-rank adaptation (LoRA) and a motion LoRA until a convergence threshold is satisfied.

19. The method as recited in claim 12, wherein the text prompt is reconstructed by replacing specific tokens with their respective superclasses, and the text prompt is used to generate an appearance noise parameter and a motion noise parameter used by the spatial-temporal algorithm.

20. A system, comprising:
a receiver configured to receive input parameters, wherein the input parameters include at least a text prompt, a set of images of two or more subjects, at least one reference motion video, and operation parameters;
a low-rank adaptation (LoRA) generator configured to generate one subject LoRA for each subject in the set of images and to generate a motion LoRA using the at least one reference motion video and an appearance-agnostic motion learning algorithm; and
one or more processors, configured to execute code to generate an output video using a spatial-temporal collaborative composition algorithm, the subject LoRAs, the motion LoRA, and the text prompt, wherein the spatial-temporal collaborative composition algorithm utilizes a diffusion model to add or subtract noise at each timestep of the output video.

21. The system as recited in claim 20, further comprising:
a transmitter configured to communicate the output video as an output to a user or a second system.

22. The system as recited in claim 20, the video, the text prompt, the subject LoRAs, and the motion LoRA are added as training data, where the output video is used as a new reference motion video for a different set of input parameters.

23. The system as recited in claim 20, further comprising:
a motion feature extractor configured to execute an appearance-agnostic motion learning algorithm using motion feature matching to train the motion LoRA, and to provide to the one or more processors extracted spatial-temporal motion trajectories from cross-attention motion dynamics and inter-frame motion dynamics from temporal self-attention maps.

24. The system as recited in claim 20, wherein the one or more processors is a machine learning system.

25. The system as recited in claim 24, wherein the machine learning system includes the LoRA generator.

26. The system as recited in claim 20, wherein the one or more processors is one or more of a central processor unit (CPU) or a graphics processor unit (GPU).

27. A non-transitory computer program product having a series of operating instructions stored on a non-transitory computer-readable medium that directs a data processing apparatus when executed thereby to perform operations, the operations comprising:
receiving at least two images, at least one motion video, and a text prompt, wherein the at least two images are images of at least two different subjects and the at least one motion video shows a motion to be applied to the at least two different subjects;
learning a reference motion by applying an appearance-agnostic motion learning process to the at least one motion video guided by the text prompt;
applying a spatial-temporal algorithm to the at least two images, the reference motion, and the text prompt to compose an initial video of the at least two different subjects; and
generating an output video using the at least two different subjects from the initial video.

28. The non-transitory computer program product as recited in claim 27, wherein the operations are performed by a machine learning system.
